(19) United States
(12) Patent Application Publication
(10) Pub. No.: US 2022/0274115 A1
(43) Pub. Date: Sep. 1, 2022

(54) SUBCULTURE SAMPLING DEVICE

(71) Applicant: NOBLE HOUSE GROUP PTY. LTD., Civic, Australian Capital Territory (AU)

(72) Inventor: Chris WHELAN, Newhall, CA (US)

(21) Appl. No.: 17/632,560

(22) PCT Filed: Aug. 3, 2020
(86) PCT No.: PCT/AU2020/050797

§ 371 Date: Feb. 3, 2022

(30) Foreign Application Priority Data
Aug. 3, 2019 (AU) 2019902782

(51) Int. Cl. B01L 3/00

(52) U.S. Cl. CPC B01L 3/5635; B01L 3/565; B01L 2200/141; B01L 2300/0681; B01L 2300/0672; B01L 2300/0832; B01L 2200/023; B01L 2200/082; B01L 2200/0689

(57) ABSTRACT

An integrally formed hollow plastics spike (14, 16) adapted to be passed through the pierceable closure of a container, the hollow spike (14, 16) having a passageway (18) extending from a first end (28) to a second end (22, 24), the passageway (18) having a length L and a cross sectional area equivalent to a 5 circle of diameter D, wherein L divided by D is more than about 19. The integrally formed hollow plastics spike (14, 16) can be integrally formed with a cap (12) to form an integrally formed sampling cap or port (10).

### FIELD OF INVENTION

This invention relates to sampling of fluid from containers and more particularly caps or ports used for obtaining a sample of fluid from another container. More particularly the invention relates to sampling caps or ports that utilise a plastic cannula rather than a metal cannula.

### BACKGROUND

Medical sampling caps or ports (hereinafter referred to as sampling cap) are used to obtain a sample of fluid from another container. Typically the source container has a pierceable but resealable closure, usually a rubber or rubber like bung. The sampling cap has a hollow cannula adapted to pierce the closure and allow a sample of fluid to be withdrawn from the source container. The fluid may be drawn into another container, such as a syringe or an evacuated tube but may be dripped directly onto test media.

The hollow passageway of the cannula and its outlet need to be sufficiently long to allow the cannula to pierce the rubber bung and also long enough to allow for dripping onto test media.

When dripping directly onto test media from an upturned source container there is no air exchange into the source container for liquid from the container. Accordingly, the size of the cannula or passageway, particularly its overall volume must be small. If the passageway volume is too large either by length, diameter or combination of both, liquid will enter the passageway but the liquid is unable to exit the passageway in the absence of an assisting force (such as suction via syringe). A longer passageway can assist with controlled droplet size and usability as the liquid can be visualised and controlled at the moment of dispensing, however passageway volume increases accordingly with length. Per the formula for cylindrical volume v=πr²h, as radius increases, so the volume increases proportional to radius to a power of 2 i.e. r². However, as cylindrical height (length) increases, the cylindrical volume increases proportional only to height to a power of 1 i.e. h. Thus, increasing the passageway length results in a proportionally lesser volume increase vs increasing the passageway diameter. A small through-hole volume means a minimum of liquid is required to get a droplet, diminishing the need for displacement.

Sampling ports may have a metal cannula or a plastics cannula. Metal cannulas may be made with a high length to internal diameter ratio. This allows the metal cannula to be a single piece that has a small internal size and sufficient length to allow drops to be easily dispensed. The metal cannula may also be bevelled to a needle point to facilitate easy piercing of the rubber septum, however this introduces a needle stick hazard that is particularly concerning when handling infectious substances, as is often the case when desiring samples from medical containers.

Plastics cannulas may also be manufactured with high length to internal diameter ratios by extrusion, but the fine design details and utility of such components are limited by the process e.g. they are a simple tube and must be assembled and bonded with other components to deliver the utility of a medical sampling cap, extruded plastics cannulas must be cut (resulting in burring), and the cut end is near impossible (corresponding to the state of the art) to make into a sharp tip suitable for a user to pierce a rubber septum without damaging the tip or the septum.

Prior art plastics cannulas for use in medical sampling caps have not been able to be made as a single component with a passageway that is both long enough and of small enough size to allow fluid, such a blood, to be dispensed drop wise with equivalent performance to a metal or extruded plastics cannula. This is because to form a hollow passageway in injection moulded plastics a (usually cylindrical) metal pin is required. The conventional thinking is that the maximum length:diameter ratio of the metal pin should be 12:1. The conventional thinking is that pins with a length:diameter ratio greater than this will be displaced by the plastics material during the injection process [and/or cooling of the plastics item] will result in distortion of the passageway and damage to the metal pin, voiding the concept of “mass-production” using such a mould. The conventional limit of a length:diameter ratio of no more than about 12:1 means that the passageway is either too wide or too short, or both.

Sampling ports with plastics cannula thus tend to be formed of two or more items, with only the cannula portion of the passageway being of a small area. This reduces the length of the steel pin in the tool to a safe limit but requires separate components.

For example, in U.S. Pat. No. 8,528,426 there is disclosed a plastics sampling port with an integrally formed cannula. Due to the aforementioned length:diameter ratio limitation only the cannula portion of the passageway is of a small area and a larger area outlet passageway is provided, reduced in effective size by a separate insert. Another option is to provide a small diameter cannula and glue or otherwise attach a separately extruded tube to achieve the small through hole all the way. Assembly is challenging because the diameters need to be precisely concentric and there can be no gap where the cannula sits. In not meeting these criteria, the fluid flow is disrupted and the device cannot serve its intended purpose of dispensing a droplet in a timely or functional fashion.

Medical devices frequently come packaged in a sterile bag. Removal of the device from the sterile bag and/or during preparation for use can expose parts of the device to accidental contamination. Being able to provide a device in a sterile state without needing to be packaged in a sterile bag can reduce the risk of accidental contamination.

### SUMMARY OF THE INVENTION

In one aspect of the invention, embodiments aim to provide an integrally formed plastics cannula or spike that has a suitably long passageway and a suitably small volume.

In another aspect of the invention, embodiments aim to provide a vent cap that may be placed on a medical device having an outlet or an inlet, so as to cover the outlet or the inlet.

In one broad form the invention provides an integrally formed hollow plastics spike adapted to be passed through the pierceable closure of a container, the hollow spike having a passageway extending from a first end to a second end, the passageway having a length L and a cross sectional area equivalent to a circle of diameter D, wherein L divided by D is more than about 19.

The integrally formed hollow plastics spike preferably comprises a hollow plastics spike portion adapted to be passed through the pierceable closure of a container and an outlet portion.

The integrally formed hollow plastics spike is preferably integrally formed with the cap portion of a sampling cap, so as to provide a single item that does not require assembly. Accordingly, in another broad form the invention provides an integrally formed sampling cap comprising a hollow plastics spike adapted to be passed through the pierceable closure of a container, the hollow spike having a passageway extending from a first end to a second end, the passageway having a cross sectional area equivalent to a circle of diameter D and a length L, wherein L divided by D is more than about 19.

The hollow plastics spike preferably comprises a hollow plastics spike portion adapted to be passed through the pierceable closure of a container and an outlet portion.

However, the cap part of the sampling cap and the integrally formed hollow plastics spike may be formed as separate components that are assembled to create the sampling cap. This allows integrally formed hollow plastics spikes to be manufactured with a single mould for use with different caps or ports. Since the cap portion of a sampling port is mainly for alignment of the source container with the spike, precision alignment is not critical.

Accordingly in another broad form the invention provides a sampling cap comprising:
a cap portion and
an integrally formed tube portion comprising a hollow plastics spike portion adapted to be passed through the pierceable closure of a medical sampling container and an outlet portion, the tube portion having a passageway extending from a free end of the spike portion to an outlet end of the outlet portion, the passageway having a cross sectional area equivalent to a circle of diameter D and a length L, wherein L divided by D is more than about 19.

The diameter D is preferably less than about 0.6 mm.

Preferably the passageway is more than about 20 mm long.

Preferably L divided by D is between 19 and 40.

In a preferred form L divided by D is at about 36.

The passageway preferably has a substantially constant cross section along its length, i.e. no draft angle. However, for manufacturing reasons the passageway may have a small draft angle. Where the passageway has a small angle or taper, preferably the draft angle is up to about 0.5 degrees. To be clear, for a circular cross section passageway, the draft angle is the angle of the walls to the centreline.

The inner end of the spike may be formed with the passageway extending out of the first end of the spike or may be formed with radially extending openings.

The other (second) end/outlet portion is preferably sized to fit within the internal passageway of a conventional male Luer fitting. More preferably, in cross section, the second end/outlet portion fits within a circle with a diameter of about 1.6 mm. Preferably, in cross section, the second end/outlet portion is circular with a diameter of about 1.6 mm.

A female Luer fitting may extend around at least part of the second end/outlet portion. Preferably the second end/free end of the outlet portion extends out of the female Luer fitting, i.e. further from the cap portion than the female Luer fitting.

Where the tubular portion is a separate component from the cap portion the female Luer fitting may be part of the tubular portion or part of the cap portion. Preferably the cap portion, tubular portion and female Luer are all integrally formed together.

Preferably the integrally formed hollow plastics spike and integrally formed sampling cap are integrally formed by a plastics injection moulding process.

The container may be a medical sample container, such as a blood culture bottle. The invention is not limited to use with medical sample containers.

In another broad form the invention provides a vent cap for a medical device having a tubular outlet, the vent cap having main body with a passageway extending through the main body and having first and second ends and at least one internal surface;
the first end adapted to receive the tubular outlet and sized so that the tubular outlet is clear of the at least one internal surface;
the second end open to the environment;
a biological filter located in the passageway;
the first end including a first sealing fitting adapted to engage a complementary second sealing fitting on the medical device, whereby, when mounted on the medical device, the first end of the passageway is blocked from communication with the environment except via the filter or the tubular outlet.

The vent cap may further comprise a retaining portion adapted to engage the medical device to retain the vent cap to the medical device.

The retaining portion may include a first screw thread adapted to engage a complementary second screw thread on the medical device.

The vent cap may comprise at least one breakable bridge connecting the retaining portion to the main body.

One of the first and second sealing fittings may comprise a male fitting and the other fitting comprises a female fitting. One of the first and second sealing fittings may comprise a male Luer fitting and other sealing fitting comprises a female Luer fitting.

The vent cap may be used with the integrally formed hollow plastics spike of the invention and also the combination of the integrally formed hollow plastics spike of the invention and a medical device, including an integrally formed medical device, such as an integrally formed sampling cap.

### BRIEF DESCRIPTION OF THE DRAWINGS

FIG. 1 shows a perspective view from above of a subculture unit according to a first embodiment of the invention.

FIG. 2 shows a plan view from below of the subculture unit of FIG. 1.

FIG. 3 shows a front view of the subculture unit of FIG. 1.

FIG. 4 shows a side view of the subculture unit of FIG. 1.

FIG. 5 shows a cross sectional view of the subculture unit taken along line AA in FIG. 3.

FIG. 6 shows a cross sectional view of the subculture unit taken along line BB in FIG. 4.

FIG. 7 shows a perspective view of the subculture unit mounted on a blood culture bottle.

FIG. 8 is a detail cross sectional view of the subculture unit mounted on a blood culture bottle.

FIG. 9 shows a perspective view from above of a tamper evident vent cap mounted on the subculture unit of FIG. 1.

FIG. 10 shows a plan view from below of the assembly.

FIG. 11 shows a front view of the assembly.

FIG. 12 shows a side view of the assembly.

FIG. 13 shows an exploded perspective view of the assembly.

FIG. 14 shows a cross sectional view of the assembly taken along line AA in FIG. 11.

FIG. 15 shows a cross sectional view of the subculture unit taken along line BB in FIG. 12.

FIG. 16 shows cross sectional view of the assembly mounted on a blood culture bottle.

FIG. 17 shows a detail cross sectional view of the assembly mounted on a blood culture bottle.

FIG. 18 shows a perspective view from above of a syringe mounted on the subculture unit of FIG. 1.

FIG. 19 shows a perspective view from above of an assembly of a subculture unit and a vent cap, according to another embodiment of the invention.

FIG. 20 shows a side view of the assembly of FIG. 19.

FIG. 21 shows a front view of the assembly of FIG. 19.

FIG. 22 shows a cross sectional view of the assembly taken along line AA in FIG. 20.

FIG. 23 shows a cross sectional view of the assembly taken along line BB in FIG. 21.

FIG. 24 shows an exploded perspective view from above of the assembly of FIG. 19.

FIG. 25 shows an exploded perspective view from below of the assembly of FIG. 19.

FIG. 26 shows a side view of the assembly of FIG. 19 after part of the vent cap removed.

FIG. 27 shows a cross sectional view of the assembly taken along line AA in FIG. 26.

FIG. 28 shows a perspective view from above of the assembly of FIG. 26.

FIG. 29 shows a perspective view from below of the assembly of FIG. 26

### DETAILED DESCRIPTION OF PREFERRED AND OTHER EMBODIMENTS

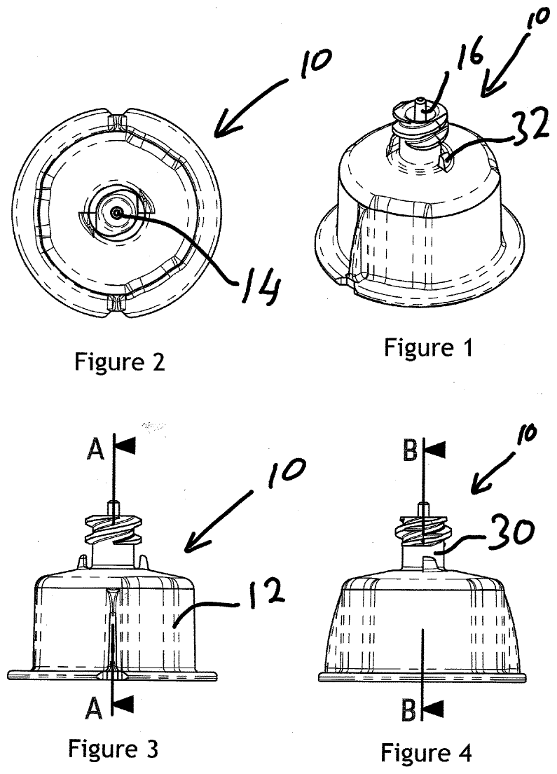

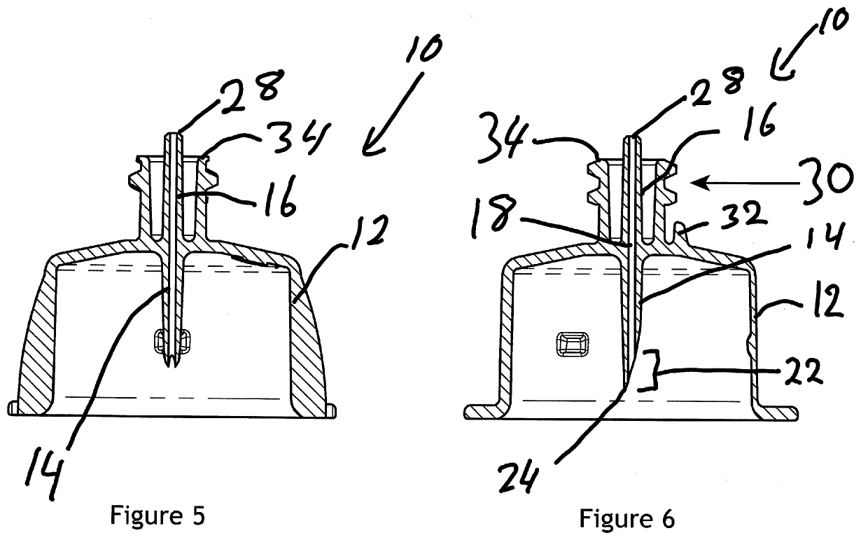

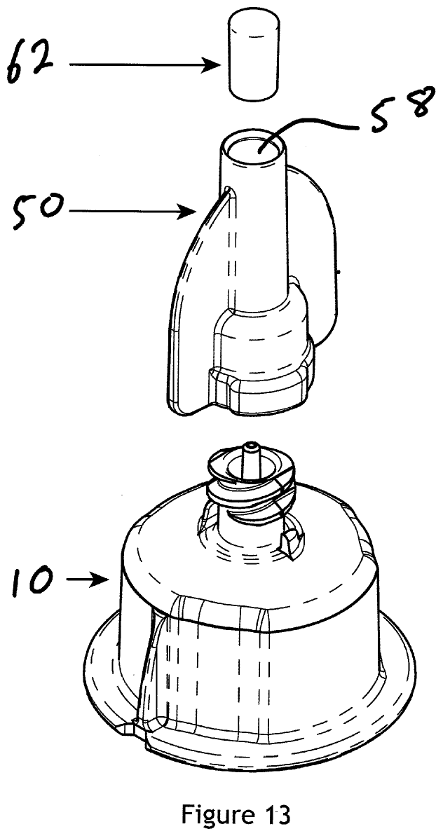

Referring to FIGS. 1 to 18 there is shown a plastics injection moulded subculture unit 10 according to a first embodiment of the invention. The subculture unit 10 is integrally formed and comprises cap 12, piercing element or cannula 14 and outlet tube 16. The subculture unit is intended to be used to withdraw samples of fluid from a blood culture bottle 100.

Cannula 14 extends within the cap 12 whilst outlet tube 16 extends out of the cap 12.

A passageway 18 extends from free end 24 of cannula 14 to free end 28 of outlet tube 16. The passageway 18 is of substantially constant cross sectional area, but for manufacturing reasons may have a slight taper. If the passageway 18 is tapered the taper preferably has a draft angle no more than about 0.5 degrees. A draft angle of 0 degrees, i.e. no taper, has been found to be preferred. The passageway 18 is preferably circular in cross section but need not be.

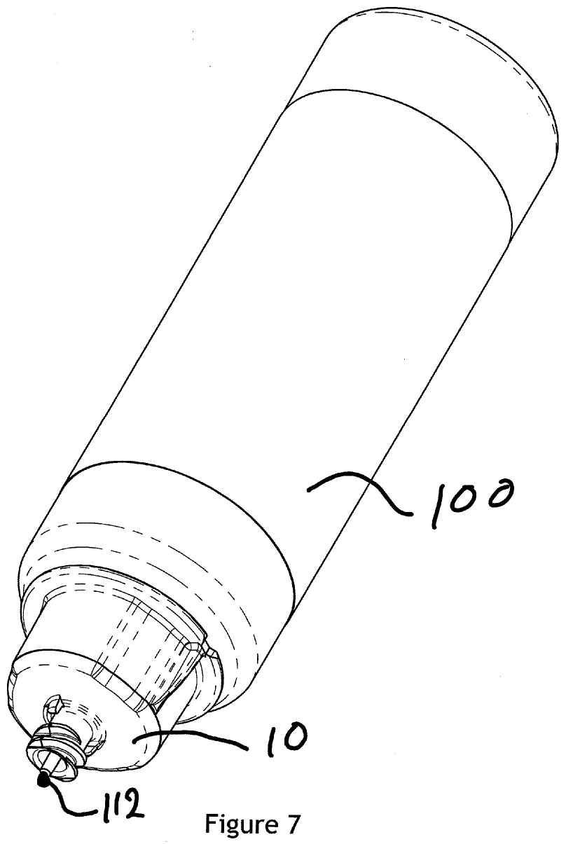

In use the blood culture bottle 100 is inserted into the cap 10 and the bung 104 of the blood culture bottle 100 is impaled on the plastics cannula 18. The cap 10 and blood culture bottle 100 may be inverted, as in FIG. 7, to cause a small amount of the fluid 110 in the blood culture bottle 100 to pass through the passageway 18 and drip onto a culture dish or sampling slide (not shown).

As discussed, the volume of the passageway 18 needs to be minimised so that the volume of fluid 110 required to be removed is minimised. Prior art blood culture sampling units utilising plastics cannulas have not been able to provide a unit in which the cannula 14 and outlet tube 16 are formed as a single component and have a small enough effective volume without the use of inserts or other components.

In the embodiment shown the passageway 18 is circular in cross section and has an internal diameter of about 0.6 mm and a fully enclosed length (i.e. excluding the length of the tapered portion 22 ending at point 24) of about 19.7 mm. Thus the passageway has a length to diameter ratio of about 33:1. Including the length of the tapered portion 22 (i.e. from outlet tube end 28 to point 24), the total length of the passageway is about 21.6 mm, giving a length to diameter ratio of about 36:1.

Where the passageway 18 is not circular in diameter, preferably the cross sectional area is equivalent to a circle of about 0.6 mm diameter.

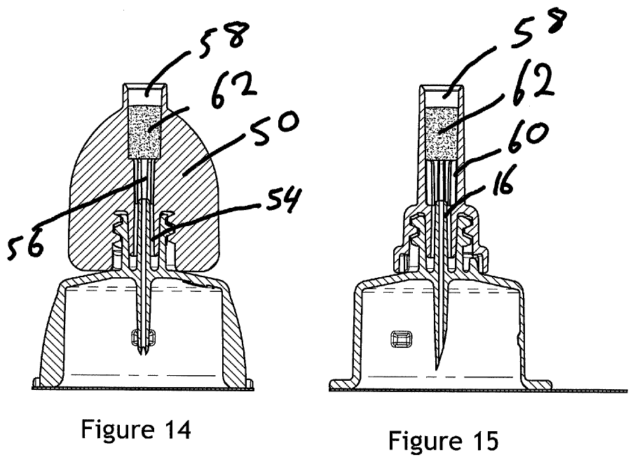

The outside diameter of the outlet tube 16 is about 1.6 mm. This is small enough to fit within the normal opening of a normal medical male Luer fitting. Accordingly, outlet tube 16 is surrounded be a female Luer fitting 30, into which a male Luer fitting may be connected, as seen in FIGS. 14 and 15. The female Luer fitting 30 is a locking fitting and accordingly has an external screw fitting 336 and locking tabs 32. These locking tabs 32 may be omitted, separately or together with the external screw fitting 336.

The outlet tube 16 preferably extends past the end 34 of the female Luer fitting 30 so that a drop 112 formed on the end 28 of the outlet tube 16 will clear the female Luer fitting 30. Whilst not desired, the end 28 of the outlet tube 16 may be flush with the end 34 of the female Luer fitting 30 or even be recessed, but this does run the risk that blood droplets may contact the female Luer fitting.

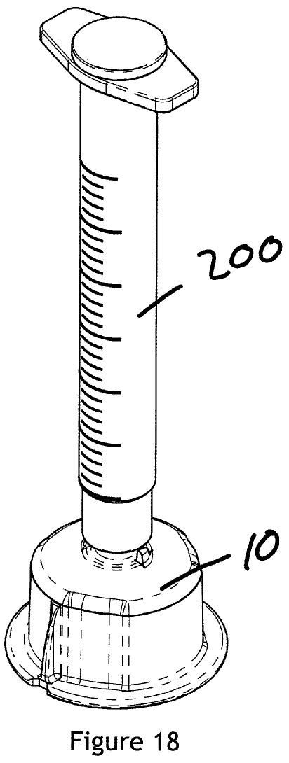

Provision of the female Luer fitting 30 allows the device to be used with syringes (see FIG. 18) and other devices with male Luer fittings, such as the vent cap shown in FIGS. 10 to 17 but, if desired, the female Luer fitting 30 may be omitted.

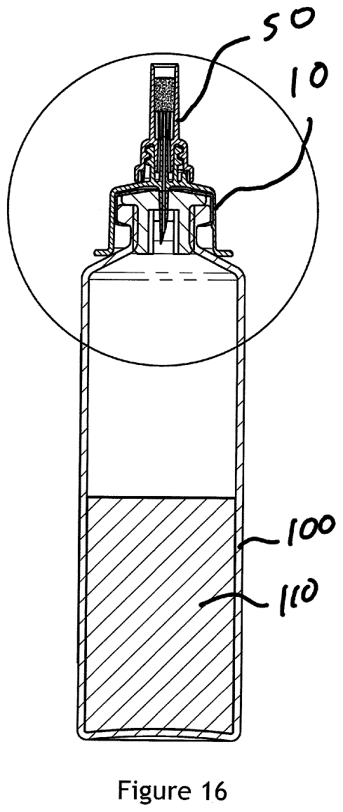

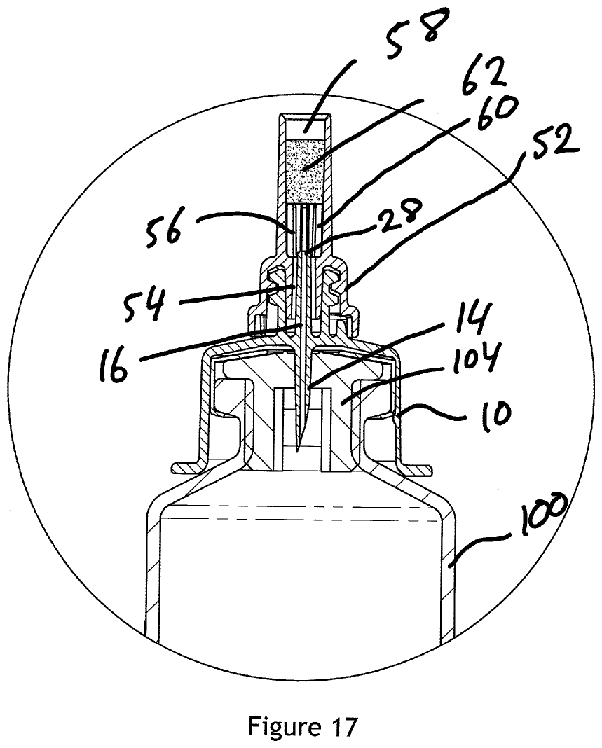

FIGS. 10 to 15 show a vent cap 50 mounted on the subculture unit 10 and FIGS. 16 and 17 show that assembly in use on a blood culture bottle. Vent cap 50 has male Luer fitting 52 that engages female Luer fitting 30. The vent cap 50 is secured against removal by locking tabs 32. As best seen on FIG. 17 the male Luer fitting has an internal passageway 54 into which outlet tube 16 extends. The outlet tube 16 communicates with volume 56. Outlet tube 16 extends into volume 56 but may end within passageway 54. The volume 56 is defined by a generally cylindrical passageway 58 with longitudinally extending ribs 60 extending radially inwards. A filter 62 is located in the passageway 58 on the open side of the ribs 60 and is located longitudinally by bearing against the ribs 60. The filter 62 is preferably an interference fit in the passageway 58, with the filter deforming and being held in place by friction. Any air movement must be through the filter 62. The filter may be made from drawn polyester yarn (DTY).

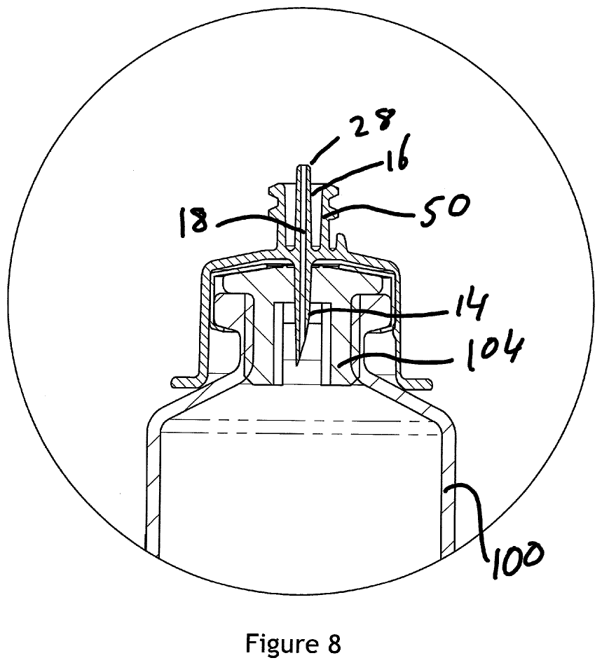

The subculture unit 10 with a vent cap 50 may be mounted on a blood culture bottle 100, as shown in FIG. 17, with the cannula piercing bung 104. Although the bung has been pierced, the contents of the blood culture bottle are maintained isolated from contaminants such as pathogens, by the filter 62. The filter may be removed to expose the outlet 16, as per FIG. 8, and samples may be obtained by inverting the bottle 100. The small volume of the passageway 18 allows samples to be obtained under gravity without the need for external assistance.

Referring to FIG. 18, a syringe 200 provided with a male Luer fitting similar to that of the vent cap 50 may be connected to the female Luer fitting of the subculture unit 10, after removal of the vent cap 50.

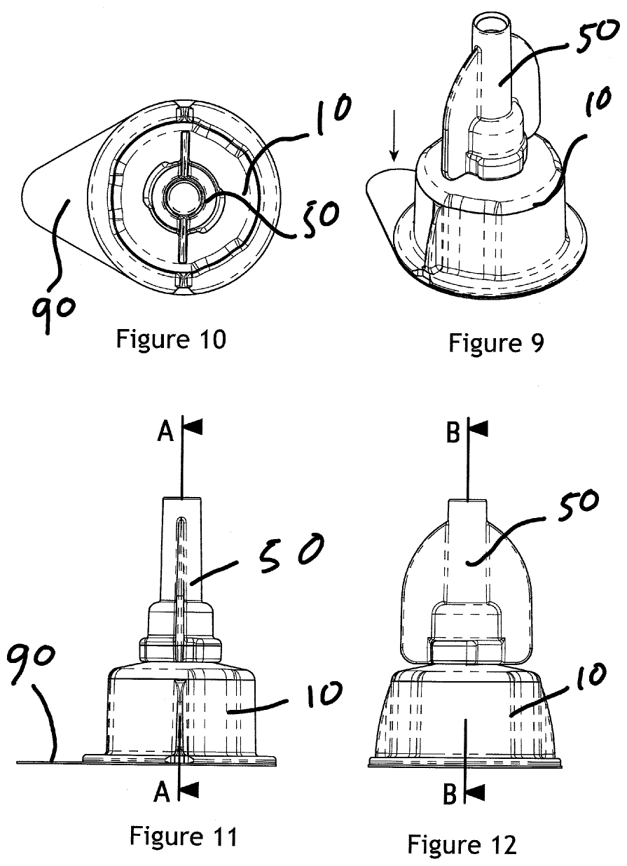

A closure 90 may be applied to the open end of the cap, as seen in FIGS. 9 to 11, to maintain sterility with the closure 90 being removed before use.

The filter 62 preferably prevents passage of bacteria and other contaminants sufficiently such that, if used with closure 90, once sterilised the product does not require any external packaging. Only the internal path of the product (the interior of the cap 12, cannula 14 and the passageway 18, etc.) that sampled fluid may contact need be sterile.

The lower edge of the cap need not seal. It is acceptable that the Luer locking thread is not fully sealed from the external environment as the blood culture sample is still only exposed to the sterile path surfaces. In addition, bacterial testing is done on the sample immediately, so any cross-contamination is an insignificant risk for creating a false-positive.

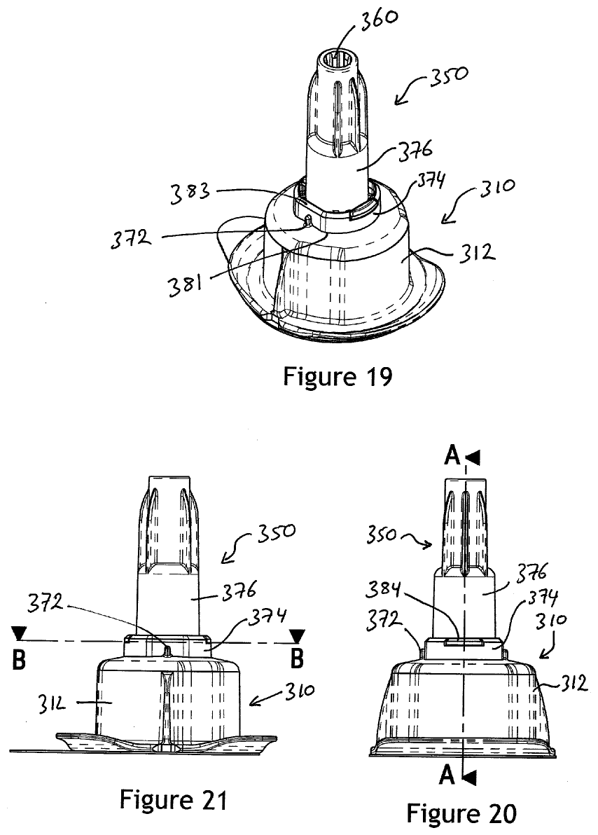

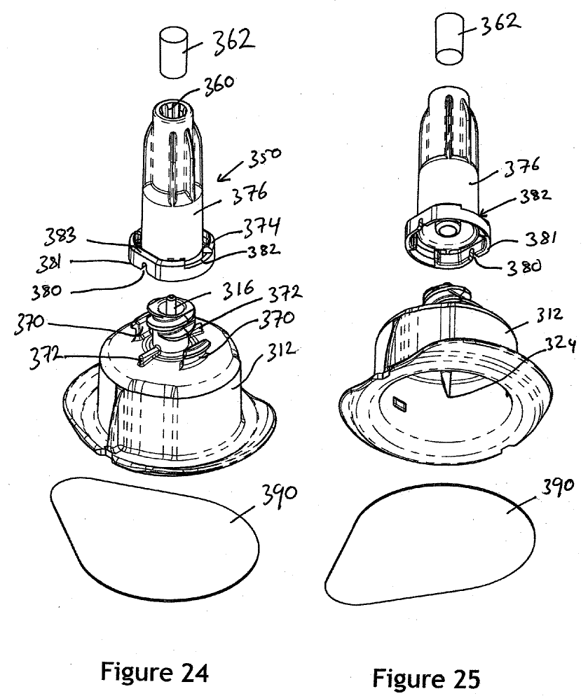

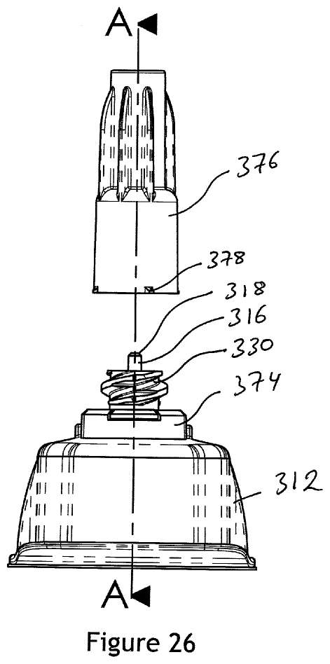

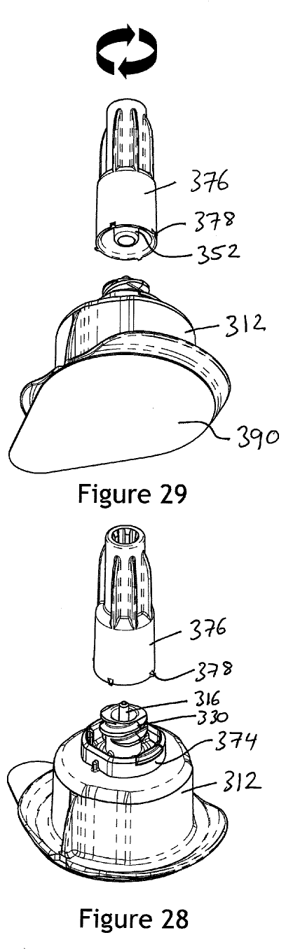

FIGS. 19 to 29 show a subculture unit 310 according to another embodiment of the invention with a tamper evident vent cap 350.

The subculture unit 310 is integrally formed and comprises cap 312, piercing element or cannula 314 and outlet tube 316. The subculture unit 310 may be used to withdraw samples of fluid from a blood culture bottle in a similar manner to the first embodiment.

The arrangement of cap 312, piercing element or cannula 314 and outlet tube 316 with each other is substantially the same as for the first embodiment. Cannula 314 extends within the cap 312 whilst outlet tube 316 extends out of the cap 312.

A passageway 318 extends from free end 324 of cannula 314 to free end 328 of outlet tube 316. The passageway 318 is of substantially constant cross sectional area, i.e. no draft angle. However, for manufacturing reasons the passageway may have a slight taper. Where the passageway has a small angle or taper, preferably the draft angle is up to about 0.5 degrees. As with the first embodiment the passageway 318 is preferably circular in cross section.

In the embodiment shown the passageway 318 is circular in cross section and has an internal diameter of about 0.6 mm and a fully enclosed length (i.e. excluding the length of the tapered portion 322 ending at point 324) of about 19.7 mm. Thus the passageway has a length to diameter ratio of about 33:1.

Including the length of the tapered portion 322 (i.e. from outlet tube end 328 to point 324), the total length of the passageway is about 21.6 mm, giving a length to diameter ratio of about 36:1.

Where the passageway 318 is not circular in diameter, preferably the cross sectional area is equivalent to a circle of about 0.6 mm diameter.

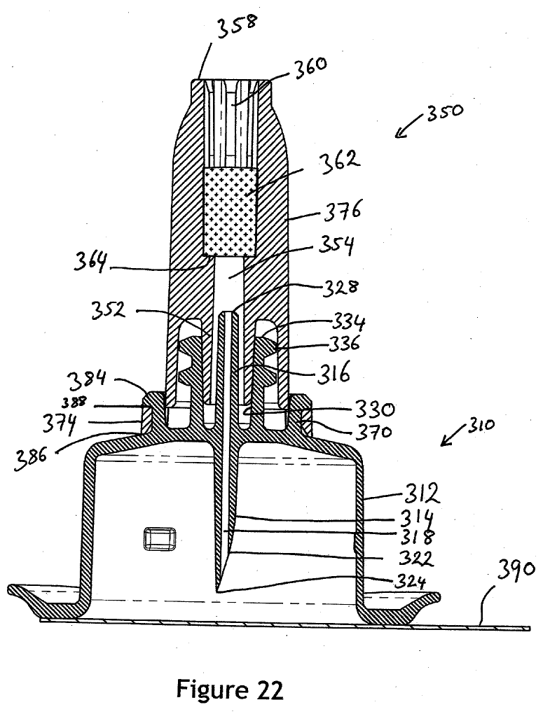

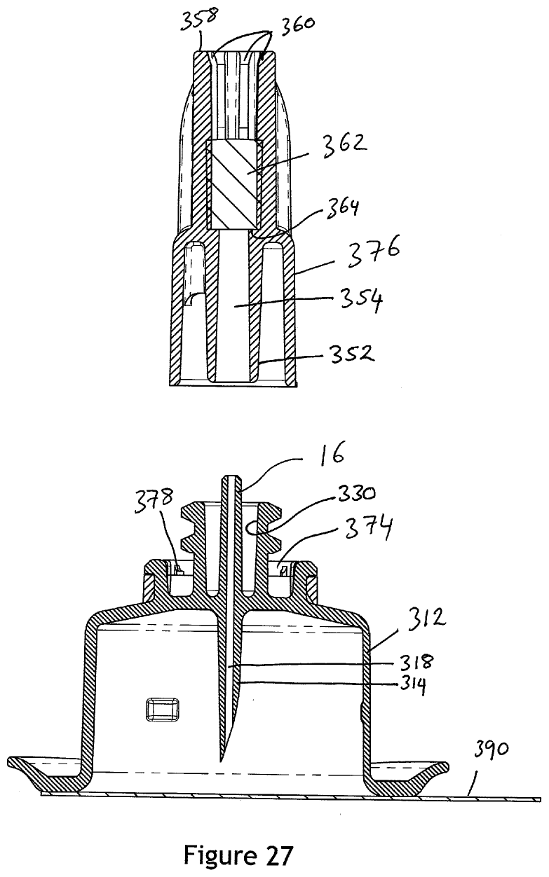

The outside diameter of the outlet tube 316 is small enough to fit within the normal opening of a male Luer fitting. The outlet tube 316 is surrounded be a female Luer fitting 330, into which a male Luer fitting may be connected, as seen in FIGS. 22 and 27. The female Luer fitting 330 has an external screw thread 336, for use with male Luer fittings that also have a corresponding screw thread. The external screw thread 336 may be omitted.

As with the first embodiment the outlet tube 316 preferably extends past the end 334 of the female Luer fitting 330 so that a drop formed on the end 328 of the outlet tube 316 will clear the female Luer fitting 330. Whilst not desired, the end 328 of the outlet tube 316 may be flush with the end 334 of the female Luer fitting 330 or even be recessed, but this does run the risk that blood droplets may contact the female Luer fitting.

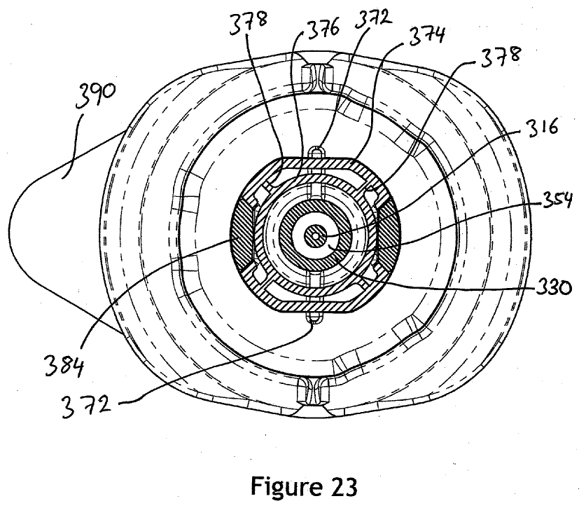

The tamper evident vent cap 350 is a push fit onto the subculture unit 310, rather than the screw fit of cap 50 for the subculture unit 10, and so does not have an internal screw thread to engage with screw thread 336. The tamper evident vent cap 350 comprises a main body 376 and a collar 374. As best seen in FIG. 23 the main body 376 and collar 374 are joined by breakable bridges 378. In the embodiment shown there are four breakable bridges 378, but the number is not critical.

The cap 312 has two diametrically opposed retaining tabs 370 on either side of the female Luer fitting. As seen in FIG. 22, these are in the form of an inverted L. The cap 312 also has two diametrically opposed radially extending walls 372, located at 90 degrees to the retaining tabs 370. The collar 370 has two recesses 380 in its lower edge 381 that are complementary to the walls 372 and two recesses 382 that are complementary to tabs 370.

The collar 374 is a snap fit on the tabs 370 and the cap 350 is mounted on the cap 312 by movement of the cap 350 downwards over the tabs 370, with tabs 370 passing between the main body 376 and the collar 374. One or more of the tabs 374, the main body 376 and collar 374 flexes to allow the tabs 374 passage. Once the horizontally extending portion 384 of each tab has passed the upper edge of recess 382 the parts return to or toward their undeflected state, with the portions 384 located in recesses 382 and walls 372 in lower recesses 380.

The portions 384 prevent the cap 350 from being simply pulled off the unit 310.

As best seen in FIG. 22 the distance between the top surface 386 of the cap 312 adjacent the collar and the lower surface 388 of portions 384 is substantially the same as the height of the recessed portion of the collar. The main body 376 also extends downwards past the tabs 370. Preferably the main body 376 is a snug fit against tabs 370, so as to substantially prevent inwards flexing of tabs 370. There may be a small gap or, alternatively, the main body 376 may be an interference fit against the tabs 370, so causing a minor outward deflection.

The collar 374 is preferably sized so that the tabs 384 are not higher than the adjacent upper edge 383 of the collar. In the embodiment shown the upper surface of the tabs 384 is substantially flush with edge 383.

The combination of the sets of recesses 380 and 382 engaging walls and tabs respectively serves to prevent rotation of the collar relative to the unit 310. The number of recesses 380 and 382 need not be the same and need not be two. There may be more or less than two of each. One of the sets of recesses 380 and 382 may be omitted. For example, recesses 380 and walls 372 may be omitted. Alternatively recesses 382 may be omitted, with tabs overlaying the collar 374.

Main body 376 has male Luer fitting 352 that engages female Luer fitting 330. Outlet tube 316 extends into the internal passageway 354. Again there is clearance between the outlet tube 316 and the inner surface of the passageway 354. The upper portion of passageway 354 has a slightly larger diameter provided with inward extending ribs 360. A suitable filter 362 is inserted from the open end 358 into passageway 354, until it bears against annular surface 364, with ribs 362 holding the filter in place. The filter 362 is preferably an interference fit in the passageway 358, with the filter deforming and being held in place by friction. The filter causes any air movement to be through the filter 362. The filter may be made from drawn polyester yarn (DTY).

A closure 390 is secured to the open end of the cap 312 and once sterilised the relevant portions of the unit 310 remain sterile until ready for use.

To remove the main body 374 and expose the female Luer fitting 330 and outlet tube 316 for use the user grasps the cap 312 and twists the main body 376 about its axis. This causes the bridges 378 to break, allowing the main body 376 to be withdrawn upwards. As mentioned, preferably the main body is removed after the assembly has been mounted on a bottle 100 or similar. The unit 310 is then used in a similar manner to the first embodiment.

Whilst the embodiments utilise a female Luer fitting into which the male portion of the vent cap engages, it will be appreciated that this is to provide compatibility with medical devices with male Luer fittings. Accordingly, the engagement between the male and female parts of the subculture units 10 and 300 and vent caps 50 and 350 need not be standard Luer fittings.

It will be appreciated that vent caps according to the invention may also be used to provide a sterile removable cover for other medical devices, so allowing supply ‘loose’ without being enclosed in a sterile bag that needs to be removed to enable handling of the medical device.

As used in the specification and/or claims the term medical device includes a component of a medical device, tool, instrument or apparatus and the like. Such a component need not be a complex component and may, for example, include a ‘simple’ component, such as a sampling cap or port.

Unless the context clearly requires otherwise, throughout the description and any claims the words “comprise”, “comprising”, and the like are to be construed in an inclusive sense as opposed to an exclusive or exhaustive sense; that is to say, in the sense of “including, but not limited to”.

The features of the invention described or mentioned in this document may be combined in any combination of features where features are not mutually exclusive.

It is to be understood that any reference to any prior art herein does not constitute an admission that the prior art forms a part of the common general knowledge in the art, in Australia or any other country.

It will be apparent to those skilled in the art that many obvious modifications and variations may be made to the embodiments described herein without departing from the spirit or scope of the invention.

The claims defining the invention are as follows:

1. A medical device comprising:
hollow plastics spike having a longitudinal direction, comprising:
a spike portion adapted to be passed through the pierceable closure of a container, and
an outlet portion,
the hollow spike having a first passageway extending from at or near the free end of the spike portion to the end of the outlet portion, and
a first sealing fitting extending around at least part of the outlet portion,
wherein a free end of the outlet portion extends longitudinally out of the sealing fitting.

2. (canceled)

3. (canceled)

4. (canceled)

5. The medical device of claim 7 wherein the diameter D is less than about 0.6 mm.

6. The medical device of claim 5 wherein the passageway is more than about 20 mm long.

7. The medical device of claim 1 wherein the first passageway having a length L and a cross sectional area equivalent to a circle of diameter D, wherein L divided by D is more than about 19.

8. The medical device of claim 17 wherein the spike portion and outlet portion are integrally formed.

9. (canceled)

10. (canceled)

11. (canceled)

12. (canceled)

13. (canceled)

14. (canceled)

15. The medical device of claim 6 wherein the outlet portion is sized to fit within the internal passageway of a conventional male Luer fitting.

16. The medical device of claim 15 wherein in cross section, the outlet portion fits within a circle with a diameter of about 1.6 mm.

17. The medical device of claim 16 wherein in cross section, the outlet portion is circular with an external diameter of about 1.6 mm.

18. (canceled)

19. (canceled)

20. The medical device of claim 8 wherein the first sealing fitting comprises a female or male fitting.

21. The medical device of claim 20 wherein the first sealing fitting comprises a female or male Luer fitting.

22. The medical device of claim 21 comprises the hollow plastics spike and a secondary component.

23. The medical device of claim 22 wherein the secondary component is integrally formed with the hollow plastics spike.

24. The medical device of claim 22 wherein the secondary component is formed separately from the hollow plastics spike.

25. The medical device of claim 23 wherein the secondary component comprises at least the cap portion of a sampling cap or port.

26. The medical device of claim 22 wherein the first sealing fitting is located on the secondary component.

27. The medical device of claim 7 consisting of the hollow plastics spike with the first sealing fitting integrally formed on the hollow plastics spike.

28. The combination of a vent cap and the medical device of claim 1, the vent cap having
a main body with a second passageway extending through the main body, the second passageway having first and second ends and at least one internal surface;
the first end adapted to receive the tubular outlet and sized so that the tubular outlet is clear of the at least one internal surface;
the second end open to the environment;
a biological filter located in the passageway;
the main body including a second sealing fitting complementary to and engaging the first sealing fitting on the medical device, with the tubular outlet extending into the first end the second passageway and being clear of the at least one internal surface,
whereby the first end of the passageway is blocked from communication with the environment except via the filter or the tubular outlet.

29. The combination of claim 28 further comprising a retaining portion engaging the medical device to retain the vent cap to the medical device.

30. (canceled)

31. (canceled)

32. (canceled)

33. (canceled)

34. (canceled)

35. A combination of claim 29 wherein the medical device comprises a sampling cap assembly comprising a cap portion and the hollow plastics spike.

36. (canceled)

37. (canceled)

38. (canceled)

39. The sampling cap assembly of claim 35 wherein the cap portion and hollow plastics spike are integrally formed.

40. The sampling cap assembly of claim 39 wherein the first sealing fitting comprises a female Luer fitting.

41. (canceled)

42. (canceled)
